(19) United States
(12) Patent Application Publication
(10) Pub. No.: US 2007/0206524 A1
(43) Pub. Date: Sep. 6, 2007

(54) Apparatus and method for acquiring paging indicator information in WCDMA system

(75) Inventor: Won-Kyu Suk, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/706,566

(22) Filed: Feb. 15, 2007

(30) Foreign Application Priority Data
Feb. 15, 2006 (KR) 14703/2006

(51) Int. Cl. H04B 7/216

(52) U.S. Cl. 370/320; 455/458; 370/318

(57) ABSTRACT

Disclosed is an apparatus and a method for acquiring paging indicator information in a Wideband Code Division Multiple Access (WCDMA) system. The method includes: storing, in a memory unit, data of paging indicator channels received in a normal mode, and transitioning to a sleep mode; transitioning from the sleep mode to a catnap mode where a normal speed clock is used; and detecting a paging indicator by using information on the starting position of a frame, information indicating the starting position of the paging indicator, and information on a section length of the paging indicator that are acquired in the catnap mode.

### PRIORITY

This application claims the benefit under 35 U.S.C. §119(a) of an application filed in the Korean Industrial Property Office on Feb. 15, 2006 and assigned Serial No. 2006-14703, the contents of which are hereby incorporated by reference.

### BACKGROUND OF THE INVENTION

1. Field of the Invention

The present invention relates to Wideband Code Division Multiple Access (WCDMA) communication, and more particularly to an apparatus and a method for acquiring paging indicator information which indicates whether to call a mobile communication terminal.

2. Description of the Related Art

In a mobile communication system of a WCDMA scheme, a User Equipment (UE) powers up a receiver of the UE once every prescribed interval according to a period (i.e., a cycle) of a Discrete Receive (DRX) that is determined from a Universal Mobile Telecommunication Systems (UMTS) Terrestrial Radio Access Network (TRAN) UTRAN 102 or a Core Network (CN), and confirms a Paging Indicator CHannel (PICH) assigned to the UE.

Setting the DRX period is so planned to save battery charge by powering down the receiver of the UE when the UE need not continuously receive a wireless signal.

The DRX UE maintains an idle state, transitions to an awake mode at the DRX period, which is a calculated value, and receives the PICH at the time of a Paging Occasion (PO) of the UE. Then, the DRX UE checks a Paging Indicator (PI) of the received PICH, ascertains that a call exists if the PI has a positive value, and performs a call procedure.

On the contrary, if the PI received at the time of the PO has a negative value, the UE waits until the next turn of the PO after the UE has powered down the receiver of the UE.

Namely, the UE stops the overall operation of the receiver in order to minimize power consumption, and provides a sleep mode function which operates in order to monitor only a prescribed part.

FIG. 1 is a view illustrating the structure of a Paging Indicator CHannel (PICH) determined in industry standards.

Referring to FIG. 1, the PICH has a length of 10 ms (the length of a wireless frame), and corresponds to a channel on which transmission is performed with a diffusion coefficient of 256 in the technology of spread spectrum. The PICH can transmit 300 bits per 10 ms. Currently, 12 bits out of 300 bits are assigned to an area that is not used, i.e., an unused area, and correspond to bits preserved for further expansion of a mobile communication system.

Therefore, the PICH can transmit 288 bits per 10 ms. Accordingly, the PICH can transfer from the minimum number of 18 PIs to the maximum number of 144 PIs per 10 ms. Namely, each PI includes from the maximum number of 16 bits to the minimum number of 2 bits, and the number of PIs which can be transmitted per 10 ms can be determined by taking the number of UEs needed for a call into consideration.

FIG. 2 is a block diagram illustrating a configuration of a conventional receiver for obtaining paging indicator information.

As shown in FIG. 2, a rake receiver 300 includes a number of fingers and a combiner, and demodulates received physical channels. Namely, each finger receives one physical channel to deliver the received physical channel to the combiner. The combiner combines signals received from the fingers to guarantee wireless signals. Herein, the rake receiver 300 performs the same channel demodulation of the PICH as another channel demodulation of a physical layer. Then, multiple fingers receive the PICHs, perform channel demodulation of the received PICHs, and deliver demodulated PICHs to the combiner. Next, the combiner combines the demodulated PIs, and determines if the PI is true or false. Then, the rake receiver 300 demodulates the PI by the bit, and confirms demodulated PI.

A search engine 310 searches for a synchronous channel that is not scrambled, with a Pseudo Noise (PN) code used for distinguishing between node Bs, ascertains which PN code the node B, to which the search engine 310 belongs, uses, and is synchronized with the physical channels scrambled by the PN code.

After the search engine 310 accomplishes time synchronization through the synchronous channel, the search engine 310 confirms the frame of 10 ms to attain slot synchronization, and finally matches synchronization of the UE and that of the node B. In other words, the search engine 310 searches for the starting position of the frame. A memory 320 stores information of the physical channels.

A PI detector 330 ascertains if there exists a call from the node B corresponding to the UE through the PI demodulated by the bit and a signal having a matched synchronization.

FIG. 3 is a view illustrating a state of the passage of time when Paging Indicator (PI) information is acquired according to the prior art.

A prior demodulation of the PICH seizes missed timing synchronization once again during a predetermined section (i.e., for a time interval from the awake mode to the sleep mode) during a process in which the UE operates in a sleep mode in order to minimize power consumption. Then, the UE enables the rake receiver to perform the PICH demodulation, and detects the PI.

With reference to FIG. 3, in the prior art as already illustrated in FIG. 2, after the search engine 310 matches synchronization with the node B, the rake receiver 300 demodulates the received PICH, and detects the PI. At this time, the search engine 310 spends 15 ms in acquiring synchronization, and the rake receiver 300 spends 20 ms in demodulating the PICH. Because it takes 1˜2 ms in acquiring each PI, total acquisition takes 40 ms at least.

Namely, the receiver is powered up to operate for at least 40 ms, and accordingly, power consumption amounts to a great deal. Moreover, the rake receiver 300 is equipped with a multitude of fingers and the combiner, and therefore has a serious problem such that the rake receiver 300 consumes a good deal of electric power in driving the fingers and the combiner.

### SUMMARY OF THE INVENTION

Accordingly, the present invention has been made to solve the above problems occurring in the prior art, and it is an aspect of the present invention to provide an apparatus and a method for acquiring paging indicator information in a Wideband Code Division Multiple Access (WCDMA) system.

Furthermore, it is another aspect of the present invention to provide an apparatus and a method for acquiring, within the shortest time, a Paging Indicator (PI) in a sleep mode for minimizing a loss of power of a User Equipment (UE) in a WCDMA system.

In accordance with an aspect of the present invention, there is provided a method for acquiring paging indicator information in a Wideband Code Division Multiple Access (WCDMA) system, including storing, in a memory unit, data of paging indicator channels received in a normal mode, and transitioning to a sleep mode; transitioning from the sleep mode to a catnap mode where a normal speed clock is used; and detecting a paging indicator by using information on the starting position of a frame, information indicating the starting position of the paging indicator, and information on a section length of the paging indicator that are acquired in the catnap mode.

In accordance with another aspect of the present invention, there is provided an apparatus for acquiring paging indicator information in a Wideband Code Division Multiple Access (WCDMA) system, including a memory unit for storing data of paging indicator channels received in a normal mode; and a paging detecting unit for confirming information of the paging indicator channels, information on the starting position of a frame, information indicating the starting position of the paging indicator, and information on a section length of the paging indicator, which are stored in the memory unit by using a normal speed clock provided by transitioning from the normal mode to a catnap mode, and for detecting the paging indicator.

### BRIEF DESCRIPTION OF THE DRAWINGS

The above and other exemplary, features, aspects, and advantages of the present invention will be more apparent from the following detailed description taken in conjunction with the accompanying drawings, in which:

FIG. 1 is a view illustrating the structure of a Paging Indicator CHannel (PICH) determined in standards;

FIG. 2 is a block diagram illustrating a configuration of a receiver for obtaining Paging Indicator (PI) information according to a prior art;

FIG. 3 is a view illustrating a state of the passage of time when PI information is acquired according to a prior art;

FIG. 4 is a view illustrating the structure of a cycle of a sleep mode applied to the present invention;

FIG. 5 is a block diagram illustrating a configuration of a receiver for acquiring PI information according to the present invention;

FIG. 6 is a view illustrating a state of the passage of time when PI information is acquired according to the present invention; and

FIG. 7 is a flowchart illustrating a process for acquiring PI information according to the present invention.

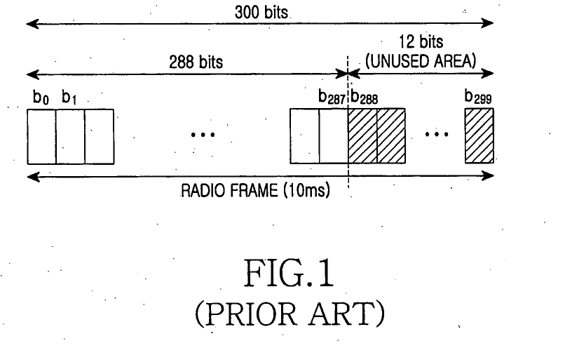

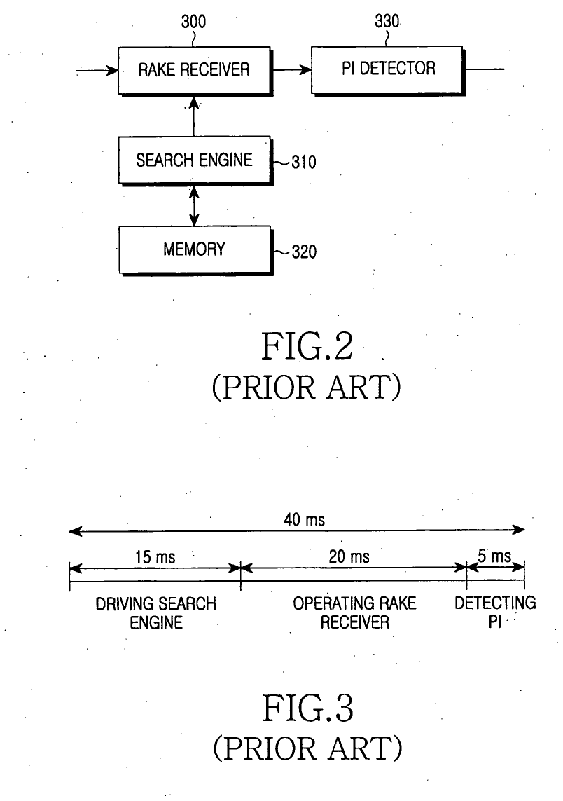

### DETAILED DESCRIPTION OF THE EXEMPLARY EMBODIMENTS

Hereinafter, exemplary embodiments of the present invention will be described with reference to the accompanying drawings. The same elements will be designated by the same reference numerals all through the following description and drawings although they are shown in different drawings. Further, in the following description of the present invention, a detailed description of known functions and configurations incorporated herein will be omitted for clarity and conciseness.

The present invention relates to an apparatus and a method in which a UE acquires a PI in a WCDMA mobile communication system. Namely, the apparatus and the method for acquiring the PI at a catnap period (i.e., a catnap cycle) of a sleep mode, i.e., in the case of the transition from a low speed clock to a normal speed clock, is provided.

The present invention provides a scheme for minimizing time necessary to acquire the PI of a PICH in the sleep mode by using information of a synchronization acquisition process obtained through a search engine in a wake-up mode. That is, without using the existing receiver equipped with the multiple fingers and the combiner in performing PICH demodulation, power consumption of the UE during the sleep mode is reduced through a first configuration for detecting the starting position of the PI, and a second configuration for ensuring the reliability of the PI detected by accumulating paging indication components, with which the present invention is newly equipped.

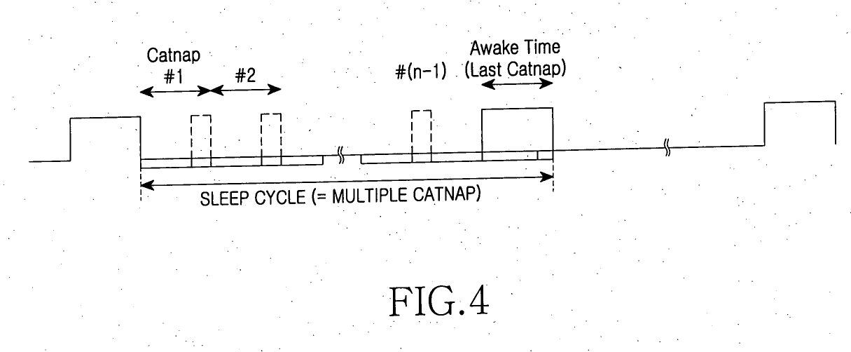

FIG. 4 is a view illustrating the structure of a cycle of a sleep mode applied to the present invention.

Referring to FIG. 4, the UE in the sleep mode enables a receiver to transition from an off state to an on state according to a sleep cycle. Namely, the receiver periodically transitions from the sleep mode to the wake-up mode according to a predetermined cycle. Herein, the clock rate (or the clock speed) of the receiver included in the UE is set in a proportional relation to power consumption, and the UE in the sleep mode is in a state where the UE is operating according to a low rate clock with which power consumption is low. In addition, the UE copes with surrounding radio paging and the generation of the interrupts according to the low rate clock.

Furthermore, in order to compensate for mobility of the UE, the UE in the sleep mode has, besides a wake-up time, catnap time by several ms so as to properly respond to the interrupts generated abruptly. For the catnap time, the receiver of the UE uses a normal rate clock. The one sleep mode cycle includes a number of (i.e., the number of ‘n’) multiple catnap times.

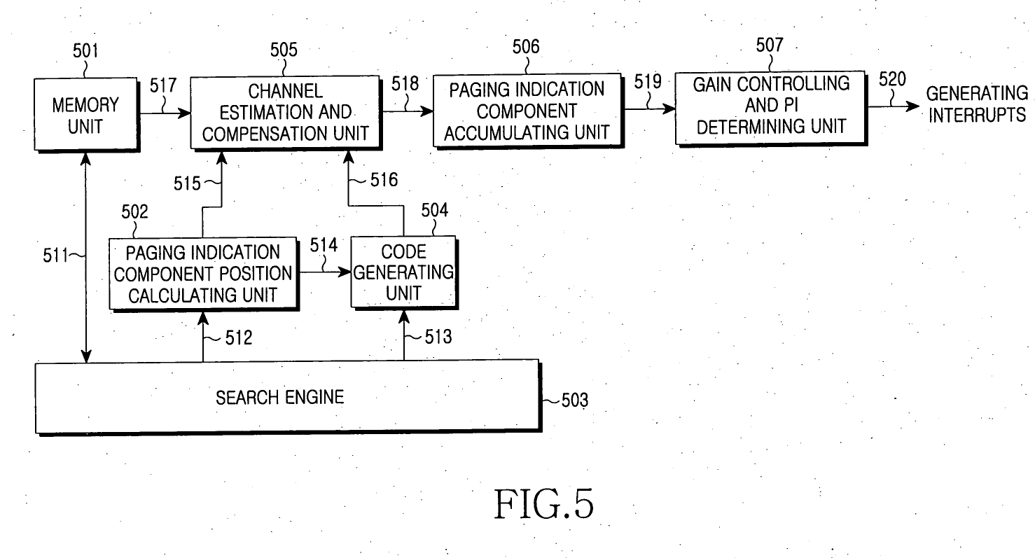

FIG. 5 is a block diagram illustrating a configuration of a receiver for acquiring PI information according to the present invention.

The UE periodically, i.e., usually about several ms, transitions to the wake-up mode during the sleep mode. At this time, in order to reflect a wireless channel environment and the mobility of the UE, timing synchronization is reacquired through the search engine. In connection with this, in the present invention, instead of processing, in real-time, channel data of the PICH received in the wake-up mode, information obtained through the wireless channel environment and the search engine in the wake-up mode is stored in a memory unit, and the synchronization acquisition is performed by using the channel data. As a result, the total time according to channel demodulation of the PICH is reduced. In other words, the memory unit is attempted to be newly defined for PI demodulation.

Referring to FIG. 5, the memory unit 501 stores data received in the wake-up mode and the channel data of the received PICH. At this time, the total 15 ms of the channel data of the received PICH is stored in the memory unit 501 in the manner of storing the eight channel data per chip. The search engine 503 performs the synchronization acquisition by using the data 511 stored in the memory unit 501. When the synchronization acquisition has been completed, the search engine 503 searches for an optimal timing among a group of multiple multi-path candidates, and acquires a scrambling code of a node B that provides the optimal timing. The search engine 503 delivers acquired timing information 512 to a paging indication component position calculating unit 502. The search engine 503 also delivers code information 513 to a code generating unit 504. An operating time of the search engine 503 becomes even shorter than a time interval (i.e., 20 ms) of two frames during which the data related to the received channels is stored in the memory unit 501. The receiver finally completes storing the data of the received channels in the memory unit 501 for 20 ms, including on/off, and goes into the sleep mode again. Then, on/off of the receiver progresses by the frame in order to maintain timing. Before entering the sleep mode, the paging indication component position calculating unit 502 keeps the starting position and the number (i.e., Nₚ value) of the PI.

Following the wake-up time, the UE reenters the sleep mode. The paging indication component position calculating unit 502 delivers PI_START_POSITION, indicating the starting position of the acquired PI to a channel estimation and compensation unit 505. At this time, the paging indication component position calculating unit 502 delivers CODE_PHASE_DELAY to the code generating unit 504. The code generating unit 504 delivers to the channel estimation and compensation unit 505 an SCR_CODE 516 obtained by compensating code phase delay for the boundary of a frame or for the starting position of the PI. The code generating unit 504 can change, into a mask value, the code phase delay whose code is generated.

From the starting position of the PI, the channel estimation and compensation unit 505 receives data provided by the memory unit 501, and estimates a channel by using a Common PIlot CHannel (CPICH) corresponding to an IDentifier (ID) ‘0’ of an Orthogonal Variable Spreading Factor (OVSF) code among the data. That is, the channel estimation is performed with respect to the data accumulated for 512 chips. In addition, the channel estimation and compensation unit 505 accumulates the relevant data for 512 chips by using the OVSF code corresponding to the PICH. Complex multiplication is carried out by using a channel estimation value and an accumulated value in order to obtain compensated data. At this time, because a value of a Status Field (SF) of the PICH equals 256, the PICH should be accumulated by the 256-chip in order to extract a relevant bit. However, since a transmitted PI has ‘1’ or ‘0’ within a relevant PI section as in TABLE 1, it is not necessary to discriminate between the PIs by the bit.

TABLE 1

| The Number of PIs | | |
|---|---|---|
| (by the frame)(Nₚ) | P_{q} = 1 | P_{q} = 0 |
| Nₚ = 18 | b16q, . . . , b16q + | b16q, . . . , b16q + |
| | 15 = 1, 1, . . . , 1 | 15 = 0, 0, . . . ,0 |
| Nₚ = 36 | b8q, . . . , b8q + 7 = | b8q, . . . , b8q + 7 = |
| | 1, 1, . . . , 1 | 0, 0, . . . , 0 |
| Nₚ = 72 | b4q, . . . , b4q + 3 = | b4q, . . . , b4q + 3 = |
| | 1, 1, . . . , 1 | 0, 0, . . . , 0 |
| Nₚ = 144 | b2q, b2q + 1 = 1, 1 | b2q, b2q + 1 = 0, 0 |

Herein, Nₚ=144 performs only 256 chips. In this manner, a paging indication component accumulating unit 506 respectively accumulates the sum of i components and the sum of q components of data whose operation has been performed by the 512- or 256-chip during a relevant PI section in order to increase reliability. Namely, because the PIs are classified into ‘1’ and ‘0,’ as shown in TABLE 1, in acquiring the PIs, the paging indication component accumulating unit 506 need check only a sign, but performs the accumulation to ensure the reliability of the PIs when channel conditions according to mobility of the UE are taken into consideration.

If a gain controlling and PI determining unit 507 determines that a PI is acquired from the accumulated values, the gain controlling and PI determining unit 507 generates the interrupt in order to exit the sleep mode. If the interrupt is generated, the UE switches from the sleep mode to a normal mode, and performs PI acquisition on-line. This is for reducing probability of a false report related to the PI acquisition such as the sleep mode.

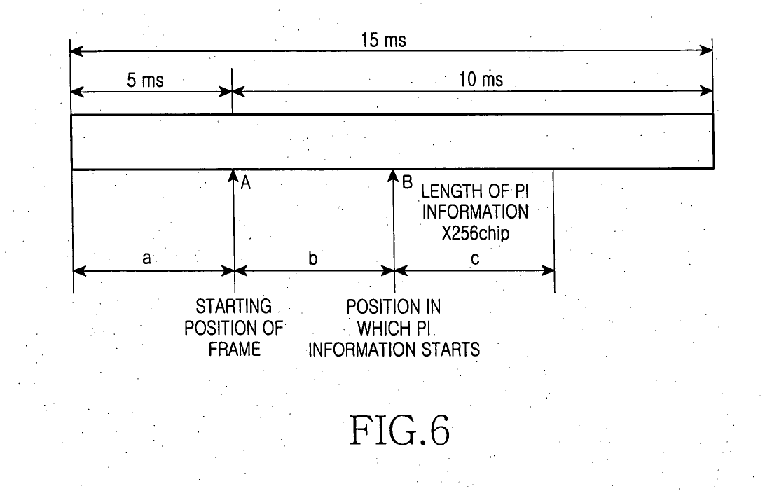

FIG. 6 is a view illustrating a state of the passage of time when PI information is acquired according to the present invention.

As previously mentioned, the PICH can transmit 288 bits during a radio frame (i.e., a standard unit of a physical channel transmission in 3^{rd} Generation Partnership Project (3GPP) having a length of 10 ms), the UEs are classified into paging groups to be called. The number of called groups can be either 144, 72, 36, or 18, and the number of bits used for a PI of each called group can be either 2, 4, 8, or 16.

$$q = [ PI + \{ 18 \times ( SEN + \frac{SFN}{8} + \frac{SFN}{64} + \frac{SFN}{512} ) \times mod 144 \times \frac{{N}_{p}}{144} \} ] \times mod {N}_{p} \qquad Equation 1$$

The UE is in a state where the UE receives, through an upper layer, both Nₚ information of a relevant group to which the UE belongs and the starting position of the PI calculated in Equation (1) in a state of the sleep mode, and stores the received information and starting position in the memory unit.

The search engine searches for the starting position A of a frame, i.e., acquires synchronization, from the data related to the channels that is being stored in the memory unit, and obtains the Nₚ information and information on a section length of the PI, which have been stored in the memory unit. Hence, the UE has only to process data by a length of c from a position B among the PICHs following an access to the memory unit. Namely, according to the present invention, the code generating unit does not sequentially create a code from the starting position of the frame, but generates a code corresponding to a point of time B to which compensation by a time interval of b is applied. Accordingly, time necessary to detect the PIs can be minimized.

Therefore, acquiring the synchronization by using the data which has been already stored in the memory unit causes time necessary to detect the frames to be reduced by a maximum interval of 5 ms. Time necessary to a PI in response to one frame is compensated by the interval of b, and therefore, acquiring the PI by accumulating the PIs in response to the PI section shortens the total necessary time.

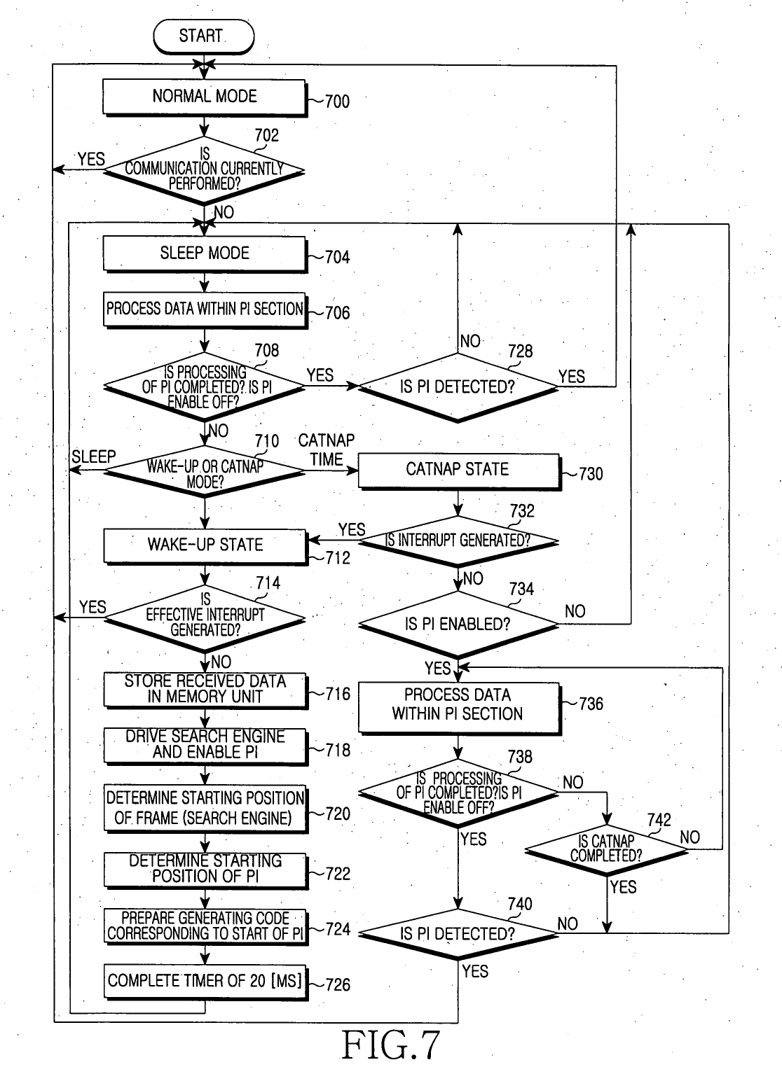

FIG. 7 is a flowchart illustrating a process for acquiring PI information according to the present invention.

Referring to FIG. 7, the UE in a normal mode in step 700 checks if communication is currently performed. If not, the UE proceeds to step 704 to transition to a sleep mode. The UE processes data within a PI section in step 706 by using data received in the normal mode in step 700. If the UE determines in step 708 that processing of the data within the PI section is completed, the UE proceeds to step 728 to detect a PI. If the PI is detected in step 728, the UE proceeds to step 700 to transition to the normal mode. If the PI is not detected in step 728, the UE proceeds to step 704 to transition to the sleep mode.

In step 710, the UE transitions to a wake-up mode according to a predetermined period (i.e., a cycle) or the UE checks if the UE is powered up in response to a normal rate clock according to a catnap time. If the UE determined in step 710 that the UE is in the wake-up mode, the UE proceeds to step 712, and checks in step 714 if an effective interrupt is generated. If the effective interrupt is generated, the UE returns to step 700 to transition to the normal mode, and receives a PICH to detect a PI.

Otherwise, if the effective interrupt is not generated, the UE proceeds to step 716 to transition to the sleep mode once again. Then, the UE uses the normal rate clock in the sleep mode. The UE stores data through physical channels received at the normal rate clock in the memory unit. In step 718, the search engine starts to drive, and enables the PI detection. In step 720, the search engine determines the starting position of a frame by using data stored in the memory unit. In step 722, the starting position of a PI is determined by using Nₚ information and information on a PI section length, which have been stored in the memory unit. In step 724, codes relevant to the start of the PI are generated, and the PICH detection is performed. In step 726, a timer of 20 ms is completed.

On the other hand, the procedure moves to step 730 to transition to a catnap mode according to the catnap time in step 710. In step 732, the UE checks if an interrupt has been generated. If so, the procedure moves to step 712 to transition to the wake-up mode. On the contrary, if not, the procedure moves to step 734 to enable the PI detection in the catnap mode. In step 736, the UE processes data within the PI section in the catnap mode. If the UE determines in step 738 that processing of the data within the PI section is completed, the procedure moves to step 740 to detect a PI. At this time, if the PI is detected, the procedure returns back to step 700.

Otherwise, if the UE determines in step 738 that processing of the data within the PI section is not completed, and if the catnap time is completed, the procedure moves to step 704 to transition to the sleep mode.

As previously described, in the present invention, the position of the PI is detected from the PICH by using the memory unit where both data received from an upper layer at the catnap time, i.e., by using the normal rate clock, and a mask value of a code for which the search engine searches, are stored. As a result, performing the PI detection according to the catnap time reduces power necessary to detect the PI, and also, time necessary to detect the PI decreases. What is more, since the position of the PI is previously stored in the memory unit, the present invention increases reliability in acquiring the PI by accumulating PI values within the PI section and determining the starting point in time of a relevant PI.

The merits and effects of exemplary embodiments, as disclosed in the present invention, and as so configured to operate above, will be described as follows.

As described above, according to the present invention, a demodulation procedure of the PICH for checking if there exists paging according to a prior art is executed not in a wake-up mode but in a catnap mode, and therefore, power consumption and demodulation time of a receiver are reduced by a great deal.

In addition, while a prior art receiver includes multiple fingers and a combiner for combining signal received from the fingers, a memory unit with which the present invention is equipped stores data of the received signals, and demodulating a PICH is performed by using the stored data. As a result, power consumption is reduced, and battery time can increase.

Furthermore, as a receiver for acquiring a PI according to the present invention is designed with a logic configuration much simpler than the prior art actual rake receiver, power consumption is remarkably reduced.

While the present invention has been shown and described with reference to a certain exemplary embodiment thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

What is claimed is:

1. A method for acquiring paging indicator information in a Wideband Code Division Multiple Access (WCDMA) system, the method comprising the steps of:
storing, in a memory unit, data of paging indicator channels received in a normal mode, and transitioning to a sleep mode;
transitioning from the sleep mode to a catnap mode where a normal speed clock is used; and
detecting a paging indicator (PI) by using first information on a starting position of a frame, second information indicating a starting position of the PI, and third information on a section length of the PI, wherein the first information, the second information, and the third information are acquired in the catnap mode.

2. The method as claimed in claim 1, which further comprises matching, by a User Equipment (UE), synchronization on a basis of the first information acquired from a search engine.

3. The method as claimed in claim 1, which further comprises accumulating, by the UE, PIs within a section length of a PI from a starting position of a PI corresponding to the UE.

4. The method as claimed in claim 3, which further comprises setting, by the UE, the corresponding PI to a result value of the accumulated PIs.

5. An apparatus for acquiring paging indicator information in a Wideband Code Division Multiple Access (WCDMA) system, the apparatus comprising:
a memory unit for storing data of paging indicator channels received in a normal mode; and
a paging detecting unit for confirming first information of the paging indicator channels, second information on a first starting position of a frame, third information indicating a second starting position of a paging indicator (PI), and fourth information on a section length of the PI, wherein the first information through the fourth information are stored in the memory unit by using a normal speed clock provided by transitioning from the normal mode to a catnap mode, and for detecting the PI.

6. The apparatus as claimed in claim 5, wherein the paging detecting unit further comprises a search engine for searching for the first starting position by using the first information, and for matching synchronization on a basis of the first starting position.

7. The apparatus as claimed in claim 6, wherein the paging detecting unit further comprises a channel estimation and compensation unit for performing a channel estimation and compensation with respect to the third information and data corresponding to the fourth information, after the matching synchronization.

8. The apparatus as claimed in claim 5, wherein the paging detecting unit further comprises a paging indication component accumulating unit for accumulating by the fourth information data received in the second starting position, and for setting a PI of the UE to a result value of the accumulated data.
